(19) United States
(12) Patent Application Publication
(10) Pub. No.: US 2003/0164875 A1
(43) Pub. Date: Sep. 4, 2003

(54) System and method for passive three-dimensional data acquisition

(76) Inventor: Kenneth J. Myers, Dobbs Ferry, NY (US)

Correspondence Address: BACON & THOMAS, PLLC, 625 SLATERS LANE, FOURTH FLOOR, ALEXANDRIA, VA, 22314

(21) Appl. No.: 10/084,932

(22) Filed: Mar. 1, 2002

(51) Int. Cl. H04N 13/04

(52) U.S. Cl. 348/52; 348/54

(57) ABSTRACT

A method and system of passively acquiring three-dimensional data concerning an object relies on comparison of changes in dimensions of the background object relative to changes in dimensions of a foreground pattern or patterns as the effective optical path length between the foreground patterns and a corresponding receiver or receivers is varied. The system and method of the invention may utilize a mirror having a pattern formed thereon that reflects a different set of wavelengths than the remaining surface of the mirror.

### BACKGROUND OF THE INVENTION

1. Field of the Invention

The present invention relates to passive three-dimensional data acquisition, i.e., acquisition of data correlated to three-dimensional spatial coordinates of a subject, by comparing changes in apparent dimensions of background and foreground images as the optical path length between the foreground image and the receiver is varied. The foreground image may be a grid or other reference image in comparison to which the dimensions of objects in the background image can be determined.

According to a first variation of the invention, the two images to be compared may be obtained by capturing a first combined image of the background and foreground, varying the optical path length by using a lens or lenses having an adjustable focal length to vary the optical path length, and capturing a second combined image of the background and foreground at the adjusted optical path length. In practice, however, it is preferred according to a second variation of the invention to capture the two combined foreground/background images simultaneously, by splitting the background image and providing two foreground images situated at different distances from corresponding receivers, thereby facilitating tracking and/or identification of moving objects.

The principle of background/foreground image comparison is similar to the effect observed when viewing an object through a multiple pane window frame or screen. As one steps back from the window, the object size increases relative to the grid formed by the window frame, i.e., the foreground decreases in size more rapidly than the background. By measuring the amount by which the apparent object size changes relative to changes in the size of the foreground window frame, one can calculate the distance to the object, and with fine enough resolution, the distance between points on the object, thereby providing data on the exact z-axis or three-dimensional coordinates of points on the object.

The system and method of the invention may be used in any application that requires acquisition of three-dimensional information about a subject, including modeling and/or analysis of three-dimensional subjects, stereoscopic imaging, and surveillance. The images may be visible light images, infrared images, ultraviolet and x-ray images, and even images formed by radiation other than light, such as alpha or beta particle radiation.

One especially advantageous application of the system and method of the invention is for passive detection and identification of moving targets, such as incoming missiles and aircraft, since the third-dimension or z-axis data is obtained without the need for scanning of the target by a projected beam or pattern, and therefore without revealing the position of the observer.

Another especially advantageous application of the system and method of the invention is for stereoscopic imaging. By utilizing two spaced-apart receivers in the manner described in the copending U.S. patent application Ser. Nos. 09/969,583, filed Oct. 4, 2001, 09/987,336, filed Nov. 14, 2001, and 10/050,538, filed Jan. 18, 2002, each of which is incorporated by reference herein, stereoscopic images may be rendered without scanning or projection of grids, in a manner which essentially mimics that of a human observer. Alternatively, the invention may use more than two receivers, receivers that are movable or pivotable, and combinations of fixed and movable receivers, depending on the application.

Finally, in order to facilitate comparison between the background and a foreground grid or pattern, the invention also provide a unique composite mirror construction that selectively reflects the grid pattern to a receiver at a different at different wavelengths than the background. This construction may be used in fully reflective mirrors, and also in beam splitters.

2. Description of Related Art

Copending U.S. patent application Ser. Nos. 09/969,583, filed Oct. 4, 2001, 09/987,336, filed Nov. 14, 2001, and 10/050,538, filed Jan. 18, 2002, disclose systems and methods of stereoscopic data acquisition in which one or more optical grids or other patterns are projected onto a subject, the distortion in the reflected grids revealing contours of the subject. To facilitate analysis of the reflected grids, the grids are optically separated from a combined image of the subject and grids using frequency sensitive beam splitters.

By enabling optical separation of projected grids that reflect contours of the subject, the systems and methods disclosed in U.S. patent application Ser. Nos. 09/987,336, 09/969,583, and 10/050,538 enable capture or rendering of images of a subject with sufficient rapidity to enable real time tracking of the subject in three dimensions, without the intensive image processing requirements of prior systems. However, projected grid systems of the type disclosed in the prior patent applications have the disadvantages that projection of the grid reveals information not only about the subject, but also about the projector. In the case of military or surveillance applications, projection of a grid or other pattern reveals the existence and/or location of the projector, rendering the projector vulnerable to discovery or attack. On the other hand, in applications involving microscopic images for scientific or medical analysis, projection of the grid may have the effect of disturbing a sensitive target and affecting the result of the analysis.

Despite the need for passive three-dimensional imaging systems, however, currently available three-dimensional imaging systems either require illumination or scanning of the target, in which case they are not passive, or seek to extract third-dimension information by taking multiple images and computationally intensive image analysis. None of the previously proposed systems, examples of which are described in the above-cited copending patent applications, utilizes the principle of passively acquiring three-dimensional data by comparing changes in the size of background and foreground images relative to fixed sets of x,y coordinates situated in two different image planes spaced apart along the z-axis parallel to the direction of the incoming image.

### SUMMARY OF THE INVENTION

It is accordingly a first objective of the invention to provide a system and method for capturing three-dimensional image data that does not require scanning or illumination of the subject by a grid or other pattern, and that therefore may be characterized as “passive.”

It is a second objective of the invention to provide a passive image capture system and method that is capable of capturing three-dimensional data concerning an object with minimal image processing, and yet with relatively simple and inexpensive hardware such as a digital camera modified to include a reference grid or grids, and/or one or more beam splitters.

It is a third objective of the invention to provide a mirror construction that selectively reflects different wavelengths of light, in order to permit a foreground grid or pattern to be superposed on a background image in a way that facilitates separation of the superposed grid and background images for processing.

These objectives are accomplished, in accordance with the principles of a preferred embodiment of the invention, by providing a system and method for acquiring data correlated with three-dimensional geometric features or location of the subject by comparing changes in the size of background and foreground images relative to fixed sets of x,y coordinates situated in two different image planes spaced apart along the z-axis parallel to the direction of the incoming image.

The method of the invention, in its broadest form, involves three steps:

a. Capturing a composite image of a background object and a foreground at a first distance from an image plane;

b. Capturing a composite image of the background and foreground in which the foreground is situated at a second distance from an image plane;

c. Comparing the relative sizes of features of the background object and the foreground in the two composite images relative to a fixed set of coordinates.

If the foreground and background images are static, then the method of the invention may easily be carried out by (i) capturing two images at different focal lengths utilizing an ordinary digital camera with a grid placed in front of the camera, and a zoom lens or interchangeable lenses having different focal lengths, and (ii) comparing the images in order to determine the amount by which the background image changes relative to the foreground image as the focal length is changed.

However, although the successive image capture method is intended to be within the scope of the invention to the extent permitted by the prior art, the more practical applications of the invention involve tracking of moving targets, in which case the composite foreground/background images to be compared must be captured simultaneously, and thus the method of a preferred embodiment of the invention includes the steps of:

a. Capturing a composite image of a background object and a foreground situated at a first distance from an image plane;

b. Simultaneously capturing the composite image for a foreground situated at a second distance from an image plane;

c. Comparing the relative sizes of features of the foreground and the background object in the composite images.

According to a preferred system for implementing the above-described simultaneous composite image capture method, an image capture device having two foreground images is provided, the background image being directed to the foreground images along two different optical paths. The foreground images are preferably in the form of grids, but may take other forms, including images of potential targets that can be matched to observed targets. The path lengths are varied, in the preferred embodiments, by using beam splitters to split the background image and direct it to the two different foreground images, and/or by placing optical elements such as lenses or mirrors having selected focal lengths in the optical path. The images are preferably captured by separate receivers and parameters of objects in the images measured electronically.

The three-dimensional data acquisition devices or cameras of the invention may be used individually in a variety of surveillance applications, or may be arranged in pairs or groups of multiple fixed or movable cameras for use in stereoscopic imaging applications, including any of the stereoscopic imaging applications described in the above-cited copending applications.

In addition to providing an improved 3D imaging system and method, the invention also provides a unique mirror construction that enables the foreground grid or pattern to more easily be separated from the background for processing. This is accomplished by treating a surface of a reflective or beam-splitting mirror in such a manner that a grid is formed on the mirror surface, either through the used of a coating, by forming the mirror of different materials, or by appropriate surface treatment methods, such that the grid or pattern reflects a different set of wavelengths than the remaining surface of the mirror. For example, the mirror may include a grid, each of the lines of which reflect a full spectrum of light, while the squares formed by the grid reflect only selected wavelengths. Separation of the images reflected by the grid lines and the squares may then be achieved by using receivers sensitive to the different wavelengths, or by wavelength-sensitive beam splitting arrangements of the type disclosed in copending U.S. patent application Ser. Nos. 09/969,583, 09/987,336, and 10/050,538.

Although the wavelength-specific pattern-reflecting mirror construction described herein is especially useful in connection with the 3D imaging system and method of the invention, it will be appreciated by those skilled in the art that the mirror may have applications other than in the 3D imaging system of the invention, including application in the systems disclosed in the above-cited copending applications. For example, the mirror construction may be placed behind a light source and used as a way to project a grid having specific wavelengths onto the subject, i.e., as a flash reflector.

### BRIEF DESCRIPTION OF THE DRAWINGS

FIGS. 1A and 1B are flowcharts showing variations of a method of passive three-dimensional data acquisition in accordance with the principles of the invention.

FIGS. 2 and 3 are schematic diagrams showing apparatus which may be used to implement the method of FIG. 1A.

FIGS. 4 and 5 are schematic diagrams showing apparatus which may be used to implement the method of FIG. 1B.

FIGS. 6-14 are schematic diagrams showing a few of the ways in which the apparatus of FIGS. 4 and 5 may be varied by arranging grids and beam splitters in different combinations.

FIGS. 15-18 are schematic diagrams showing further variations of the apparatus illustrated in FIGS. 4 and 5, arranged to capture thermal profiles of objects.

FIGS. 19A and 19B are, respectively, a plan view and a perspective view of a mirror construction suitable for use in connection with the imaging systems illustrated in FIGS. 1-18.

### DETAILED DESCRIPTION OF THE PREFERRED EMBODIMENTS

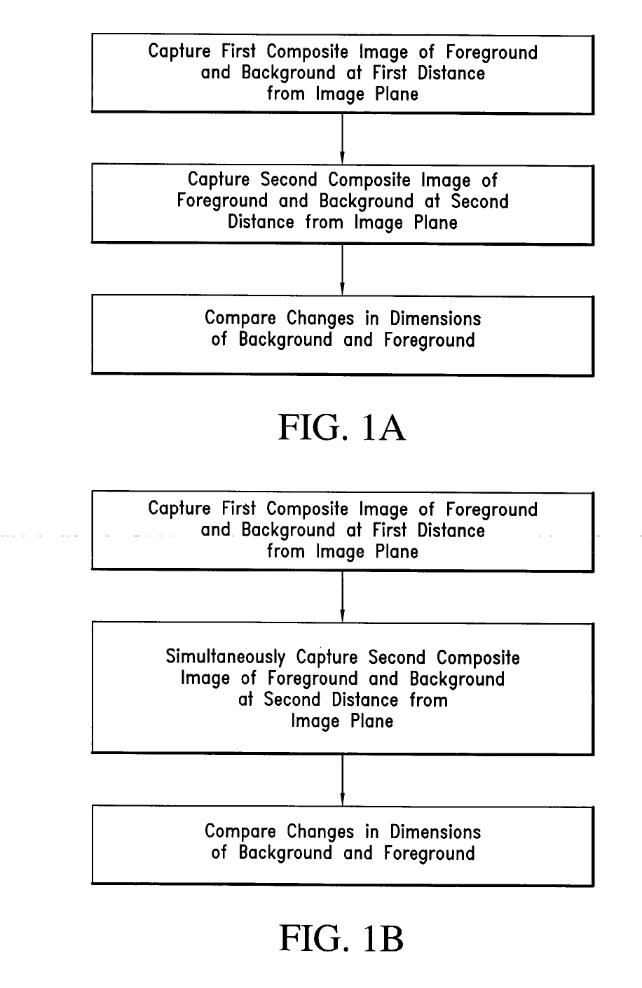

As illustrated in FIG. 1A, the method of the invention, in its broadest form, involves three steps:

a. Capturing a foreground image and a background image at a first distance from an image plane, the background image containing an object whose three-dimensional parameters are to be analyzed and the foreground image containing a reference pattern (step 100);

b. Capturing the foreground background images at a second distance from an image plane (step 110);

c. Comparing the relative sizes of the foreground and background images, or the relative apparent distances between points of features in the images at the two distances (step 120).

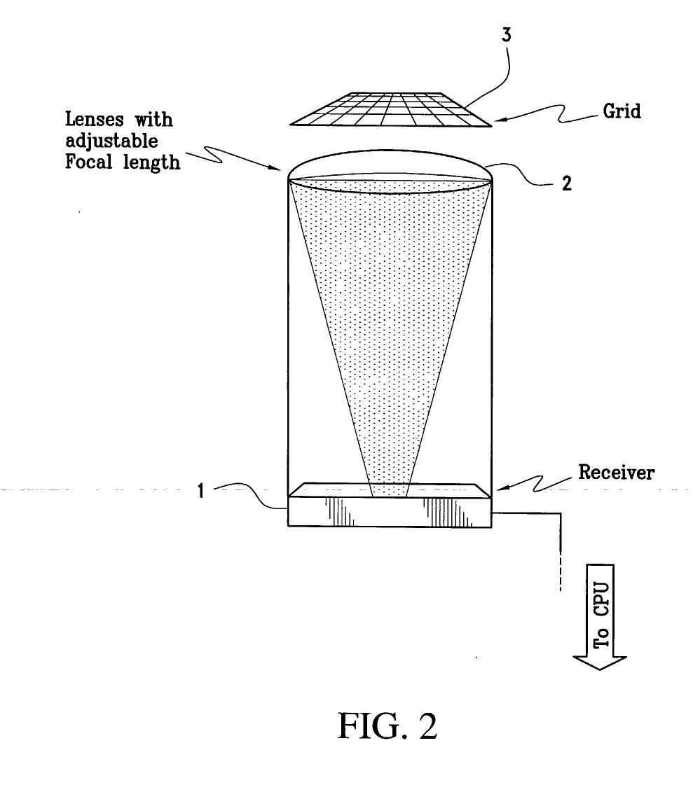

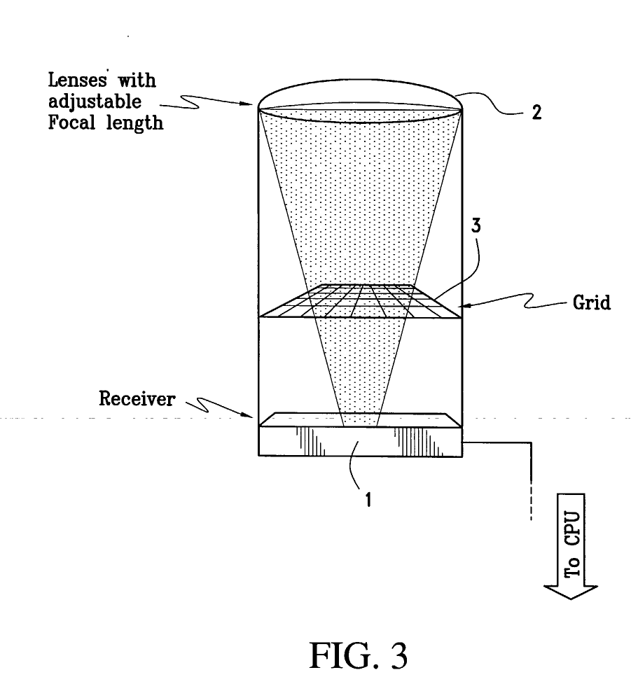

If the foreground and background images are static, then the method of the invention may be carried out by capturing two images at different focal lengths utilizing an ordinary digital camera having a CCD 1 situated at the image plane, and one or more lenses 2 for varying the effective distance between from the image plane to the foreground image 3, as illustrated in FIGS. 2 and 3. In that case, distance between the image plane and foreground image may be adjusted by varying the focal length of a conventional zoom lens, or by replacing lens of fixed focal length between images, and the the foreground image may be a grid placed inside or outside the lens or lenses used to capture the two images, or some other pattern by which the relative sizes of the background and foreground images may be ascertained.

Although the system of FIGS. 2 and 3, and the corresponding method of successively capturing the composite background/foreground images to be compared, is intended to be within the scope of the invention to the extent permitted by the prior art, the more practical applications of the invention involve tracking of moving targets. In such applications, the images to be compared must be captured simultaneously, and thus the method of the invention preferably includes, as illustrated in FIG. 1B, the steps of:

a. Capturing a foreground image and a background image at a first distance from an image plane (step 200);

b. Simultaneously capturing a foreground image and a background image at a second distance from an image plane (step 210);

c. Comparing the relative sizes of the foreground and background images, or the relative apparent distances between points of features in the images at the two distances (step 220).

According to a preferred embodiment of a system for implementing the above-described simultaneous foreground/background image capture method of the invention, an image capture device having two foreground images is provided, the background image being captured with the foreground images along two different optical paths. The foreground images are again preferably in the form of grids, but may take other forms, including images of potential targets that can be matched to observed targets. The path lengths are varied, in the preferred embodiments, by using at least one beam splitter 6 to split the background image and direct it through the two different foreground images 4,5 to different receivers 7,8 located in different image planes, and/or by placing optical elements such as lenses 9,10 and/or mirror(s) 11 having selected focal lengths in the optical path. Those skilled in the art will appreciate that the use of lenses or other optical elements such as mirrors having different focal lengths is useful for increasing the apparent separation between the image planes in which the relative sizes of the foreground and background images are to be compared, but that in principle the simultaneous superposition of the background image on foreground images that are a different optical distance from the image planes should be sufficient to acquire useful three-dimensional information.

Critical requirements for the acquisition of meaningful three-dimensional data are that the foreground image be separated from the respective receivers, and that the separation be by different apparent amounts. So long as these requirements are met, the manner in which the optical path lengths differ may be varied in any convenient manner without affecting the operation of the system. For example, instead of varying the focal lengths of lenses 9 and 10, grids 4 and 5 may be physically moved relative to the receivers 7 and 8, by a motor, piezoelectric actuator, or the like. The term “apparent” is used because the grids may actually be separated by the same physical distance if they have different sizes.

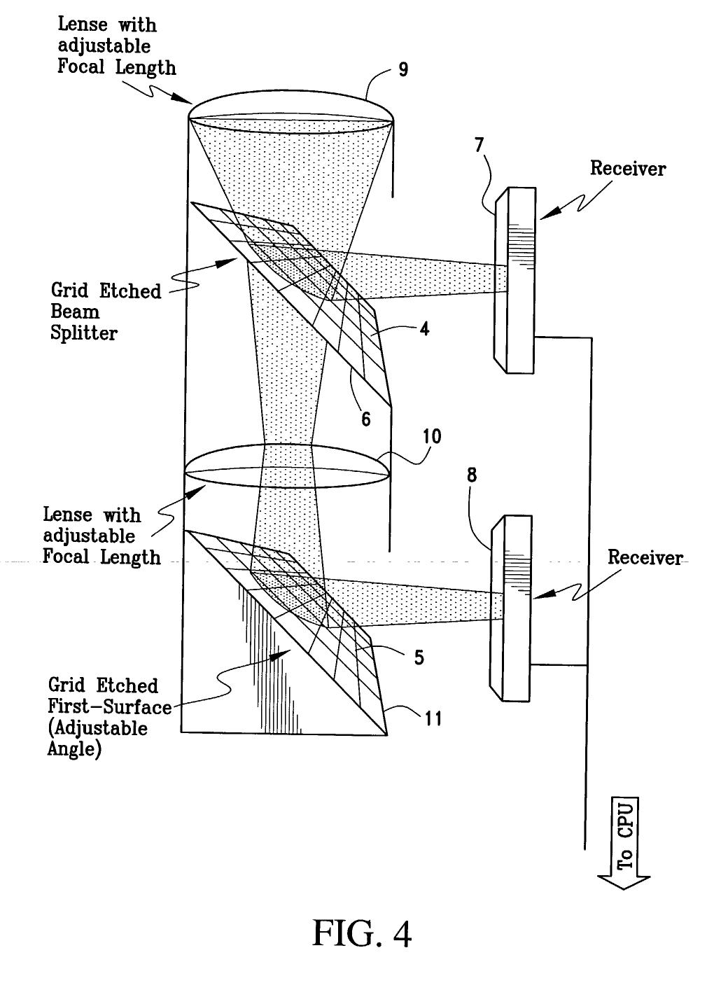

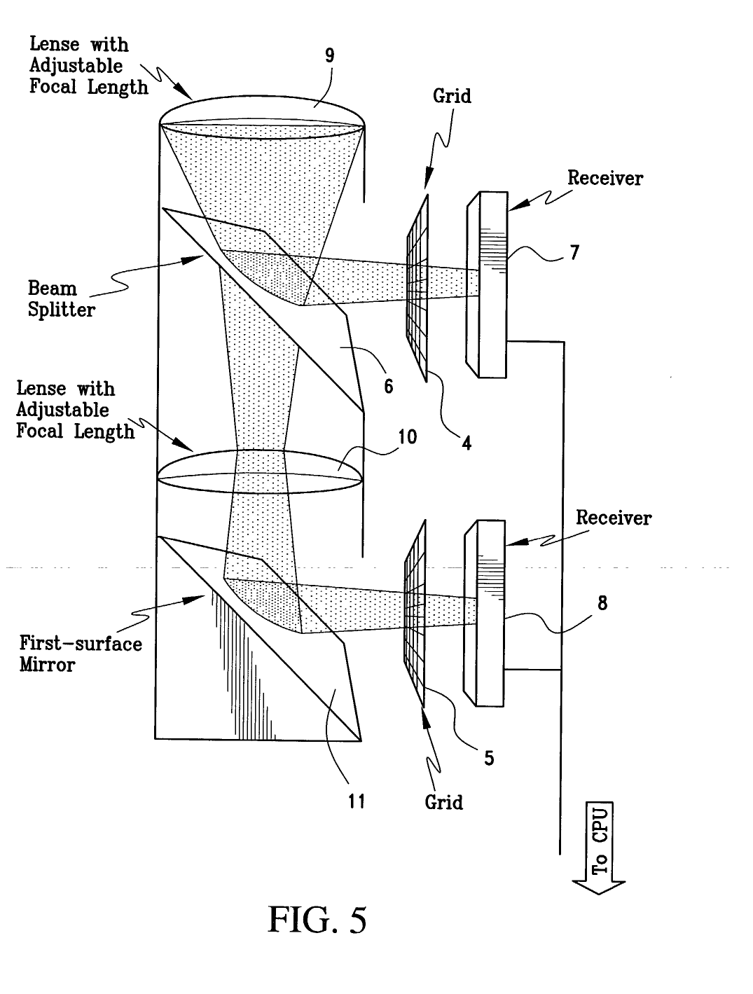

The difference between the embodiment illustrated in FIG. 4 and the embodiment illustrated in FIG. 5 concerns the placement of the foreground images, i.e., the grids of patterns 4,5. In the embodiment of FIG. 4, the grids 4,5 are situated on the beam splitter 6 and a mirror 11 that directs the background image to the second receiver, for example by etching the grid into a surface of the beam splitter and mirror, while in the embodiment of FIG. 5, the grids are positioned between the beam splitter and mirror and the receivers 7,8. In addition, in the embodiment illustrated in FIG. 4, mirror 11 may be made adjustable to compensate for the apparent change in position of the grid 5 resulting from adjustment of the focal length of lens 10, while in the embodiment of FIG. 5, mirror 11 may be deleted and the receiver and grid positioned directly below the beam splitter.

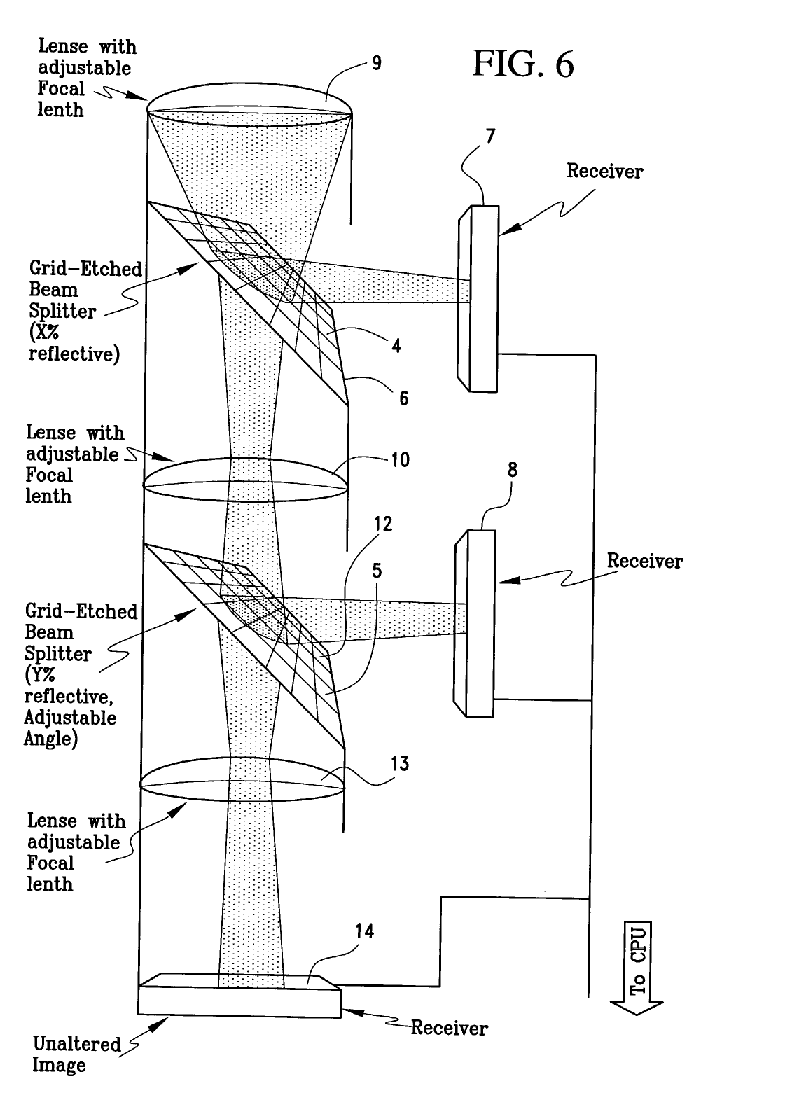

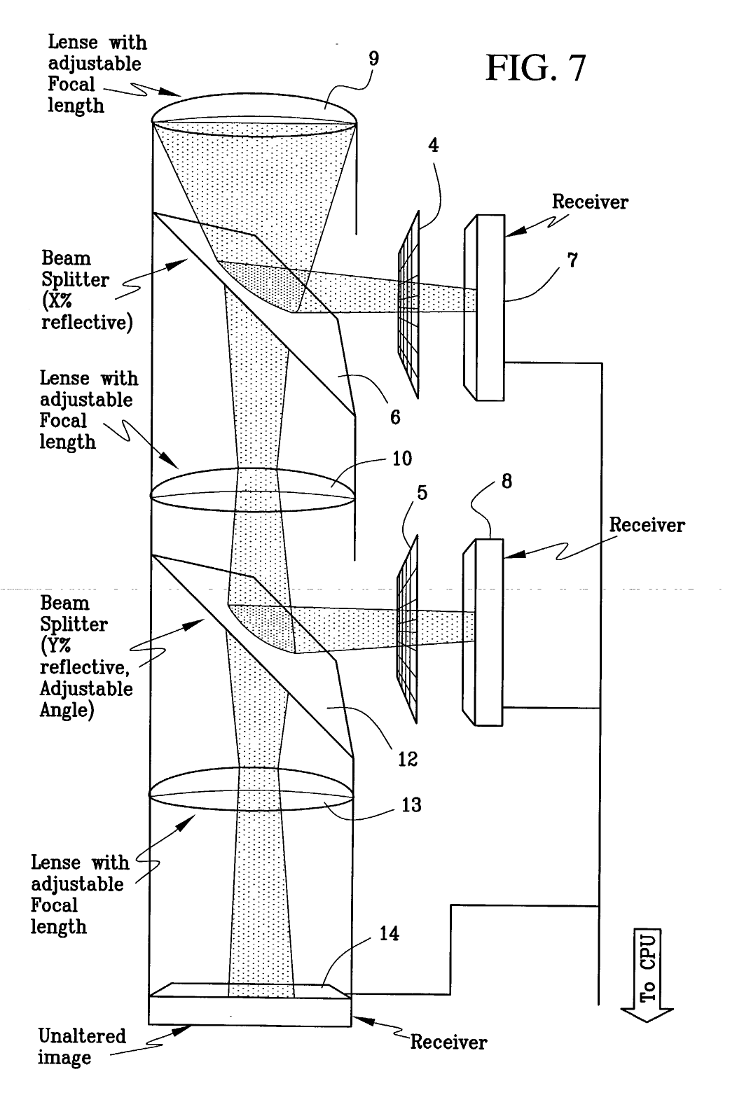

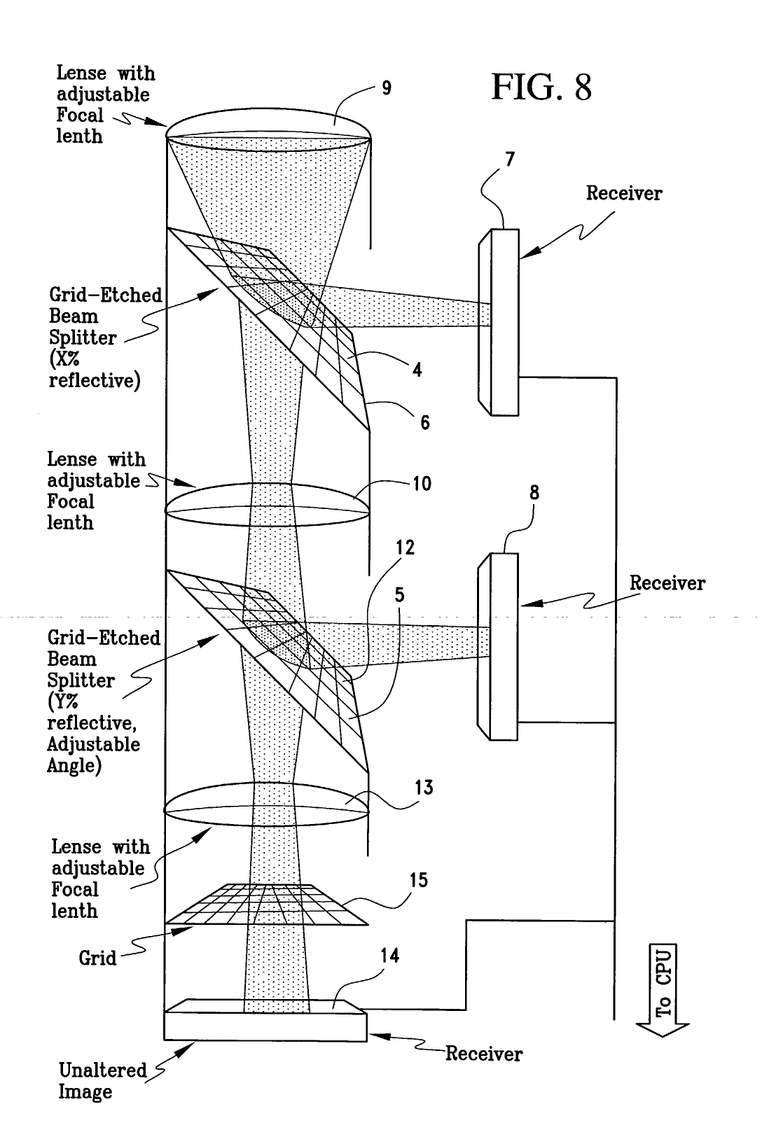

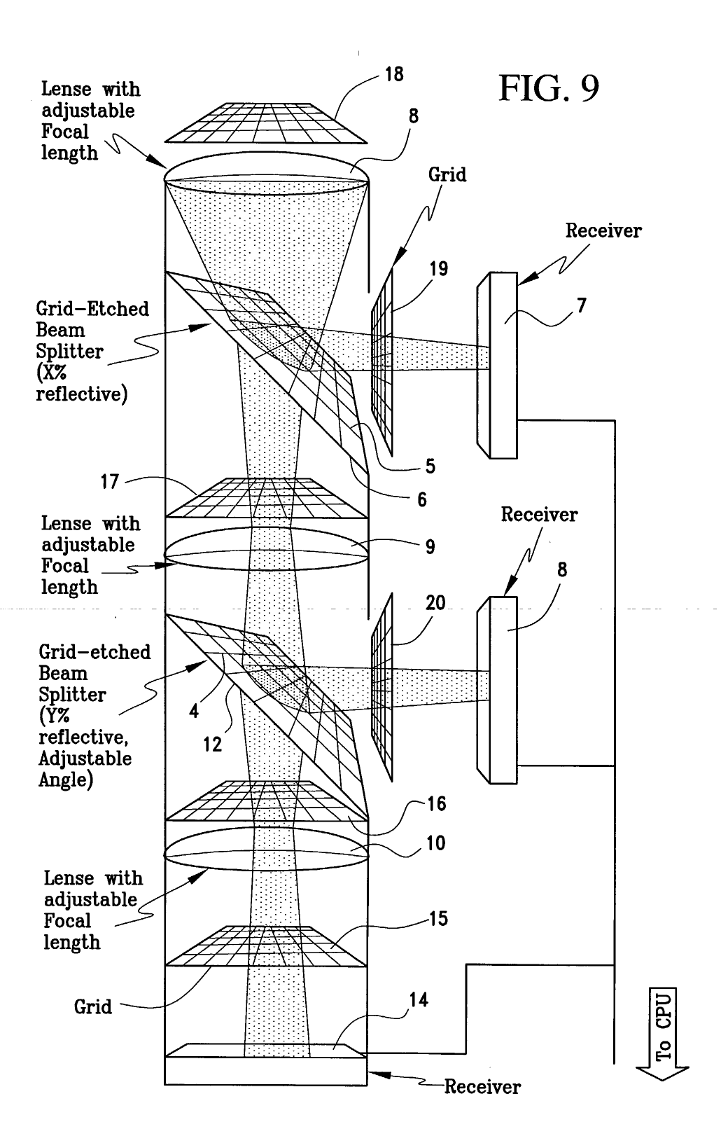

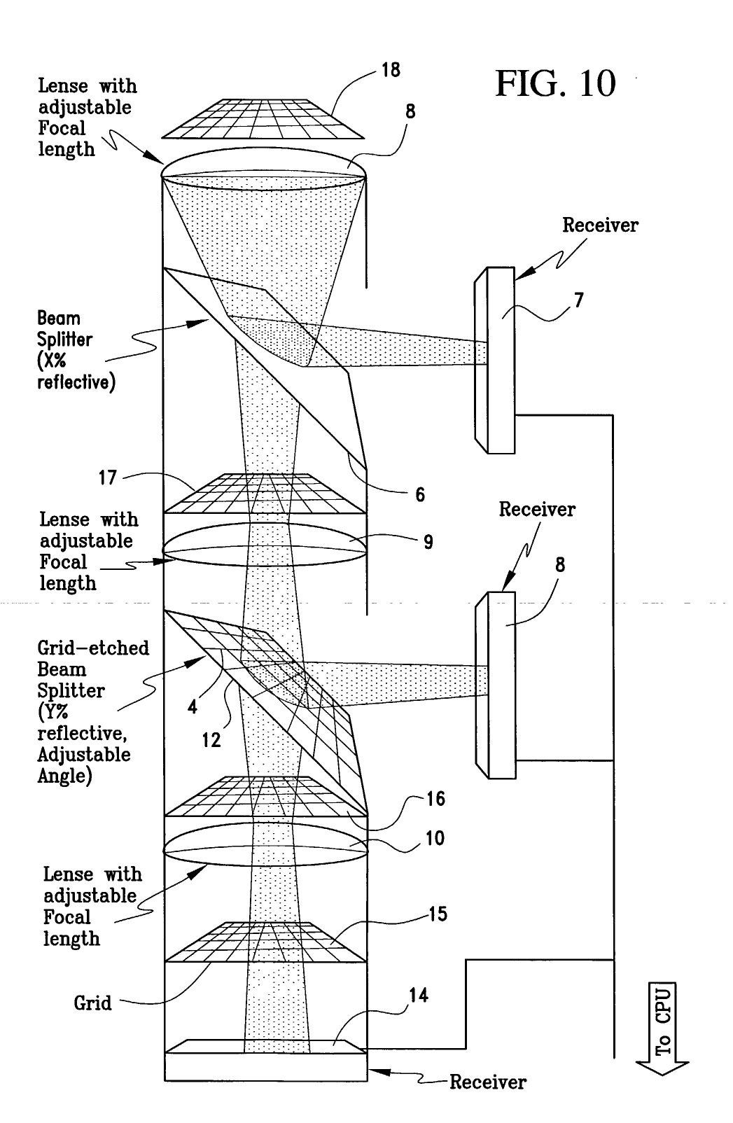

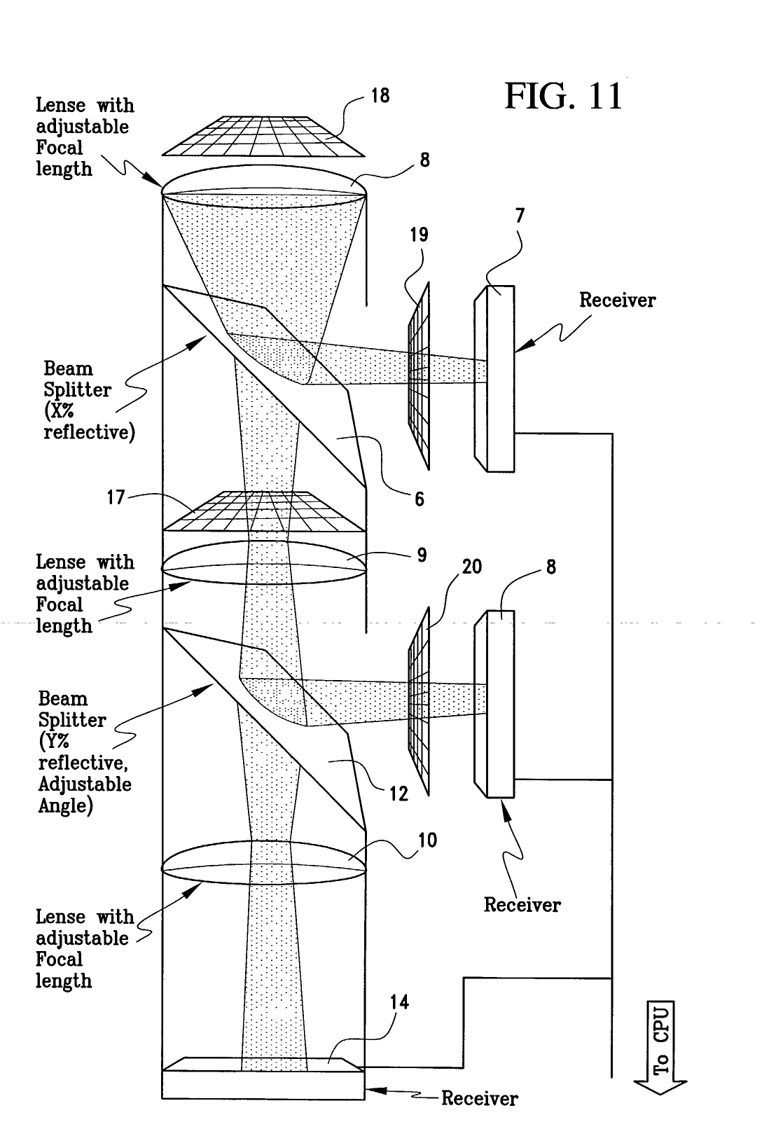

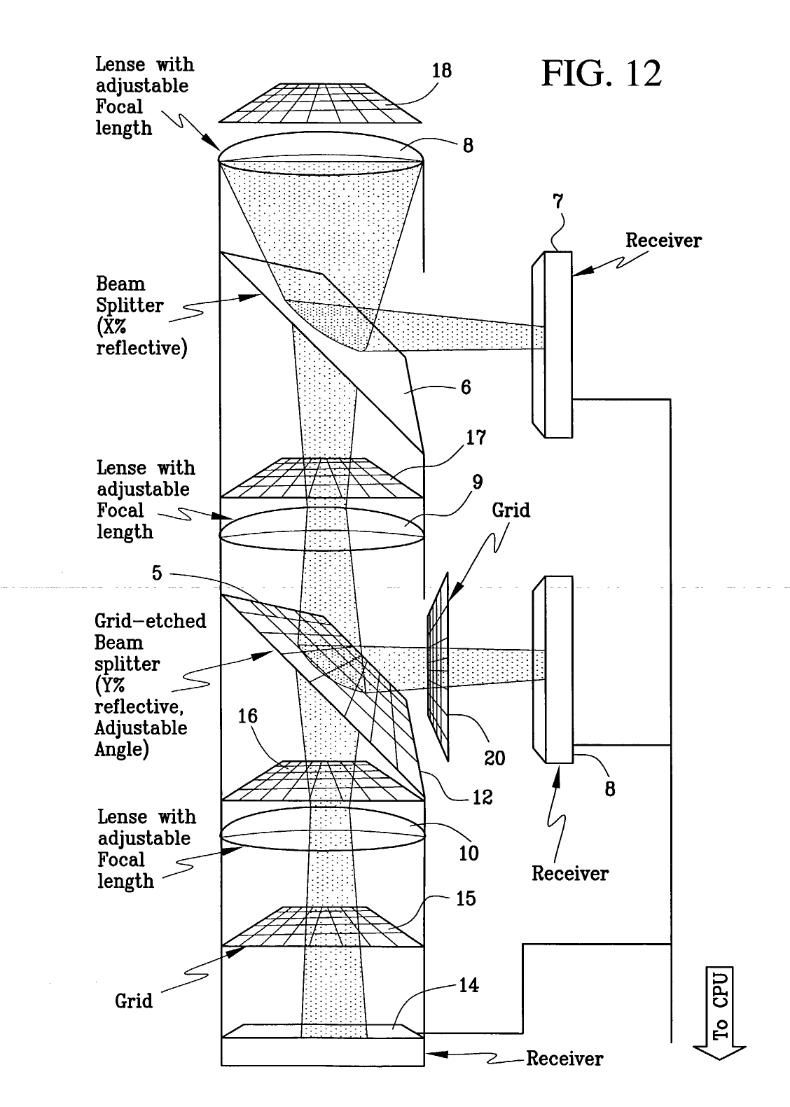

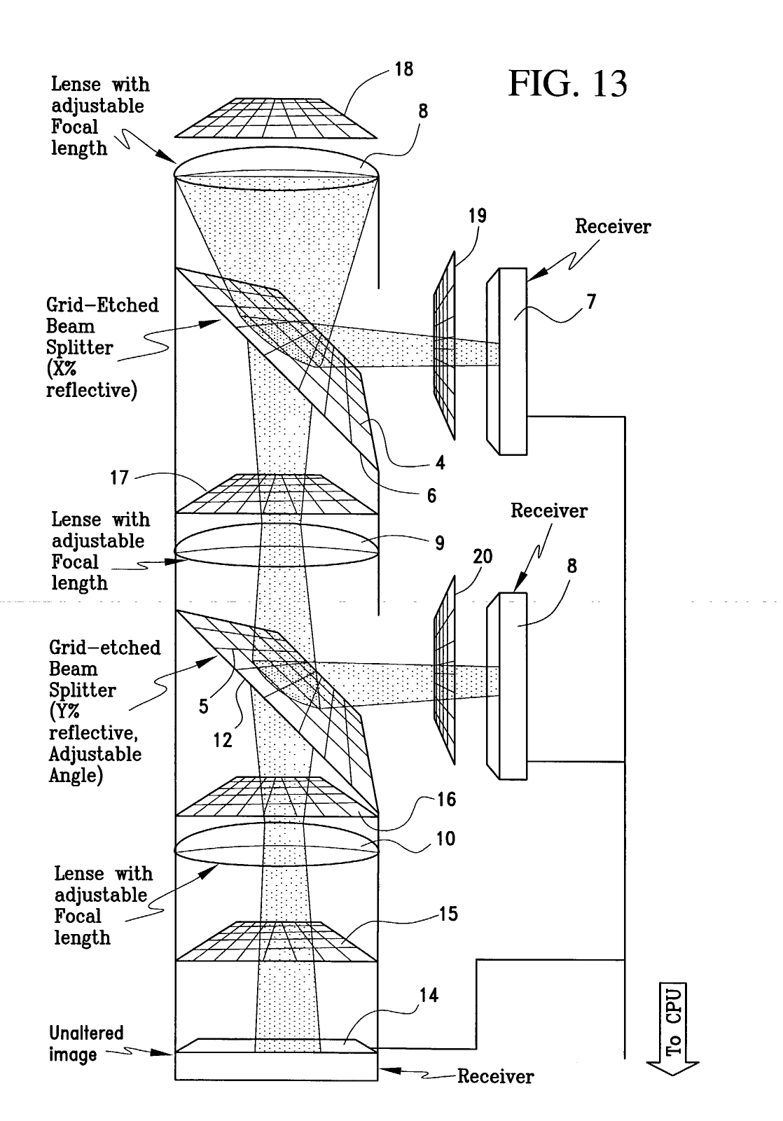

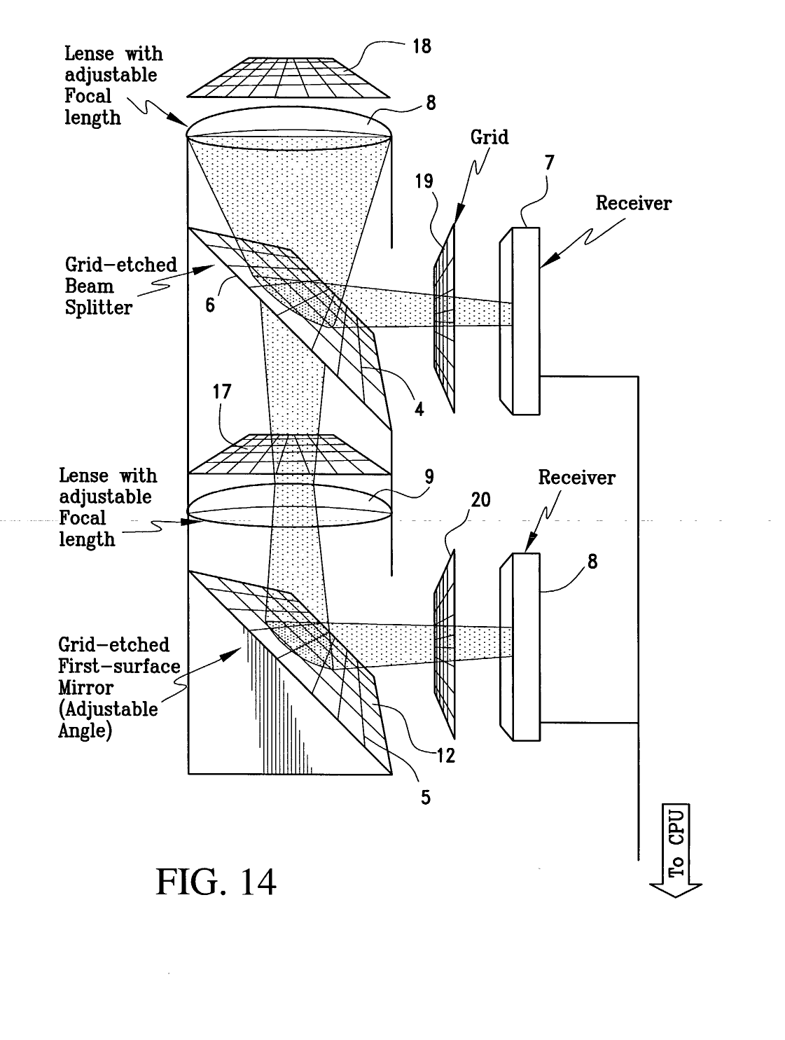

In the embodiment illustrated in FIGS. 6 and 7, mirror 11 of FIGS. 4 and 5 is respectively replaced by a second beam splitter 12, and a third adjustable focal length lens 13 and receiver 14 are added in order to provide a reference image which may be used for calibration purposes, i.e., to decrease the effects of uncertainties or tolerances in the first two optical paths. In addition, the third optical path and/or the first and second optical paths (whether or not a third optical path is provided) may include any combination of one or more further grids or reference patterns 15, 16, 17, 18, 19, and/or 20 while omitting any of grids 4 or 5, as illustrated in FIGS. 8-14, which show a variety, but not all, of the different combinations of grids, lenses, and beam splitters that fall within the scope of the invention.

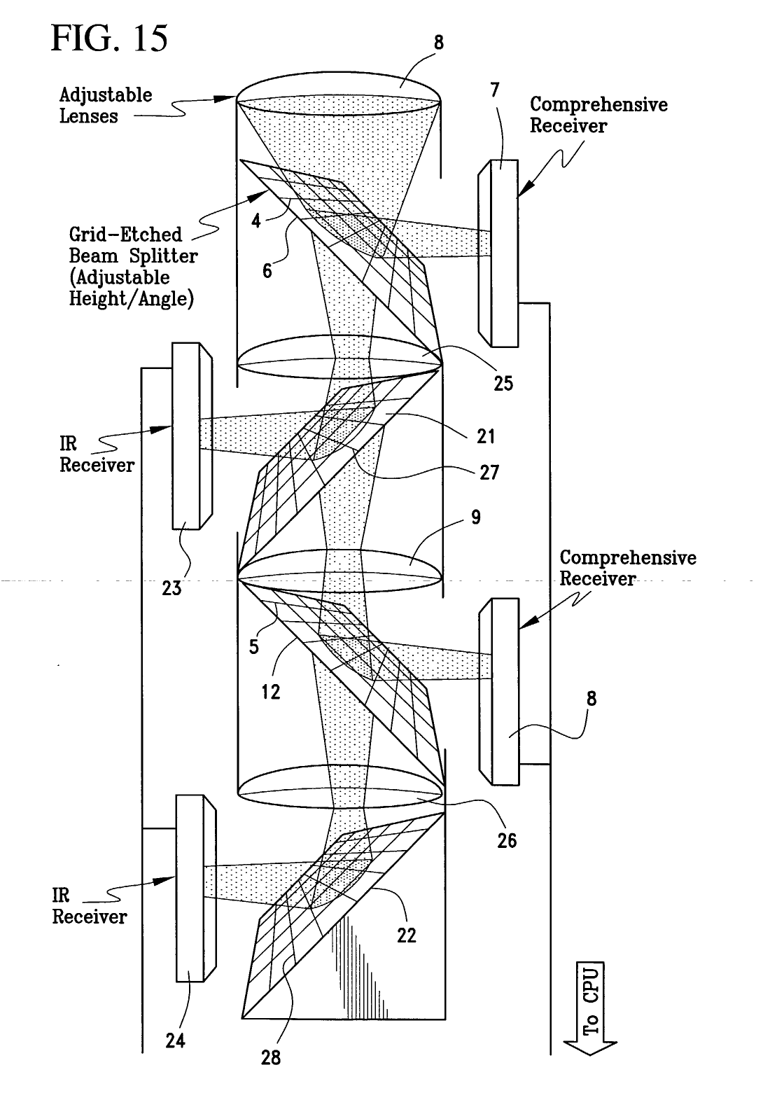

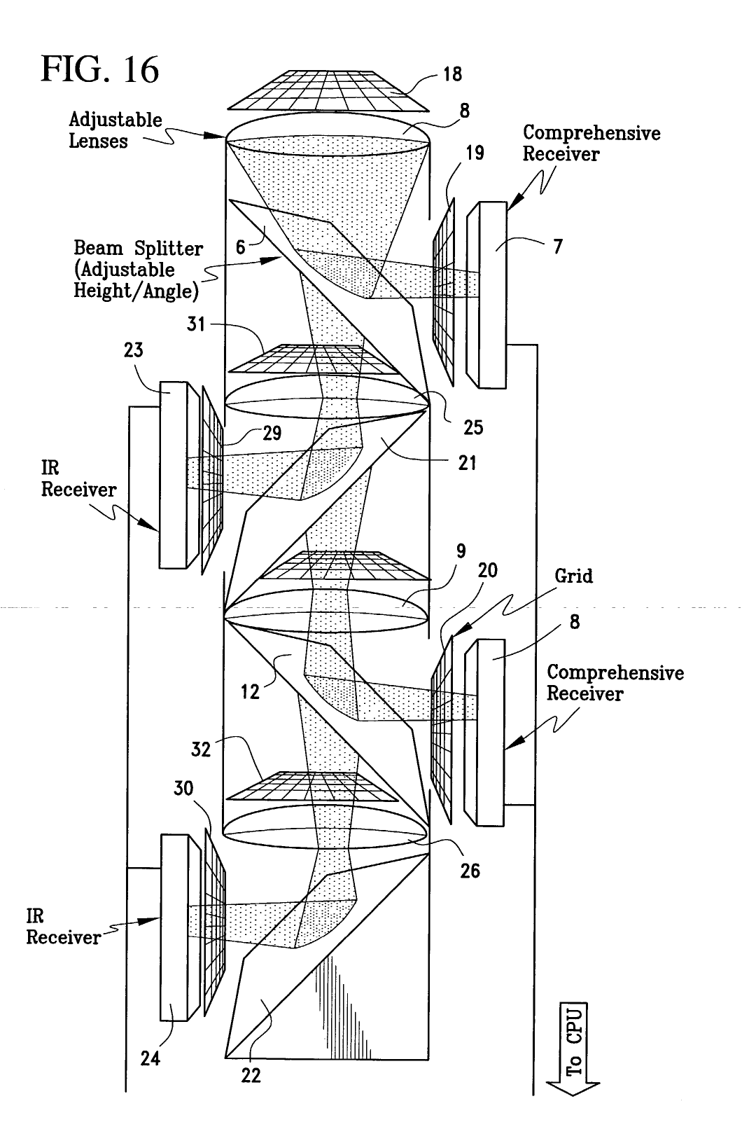

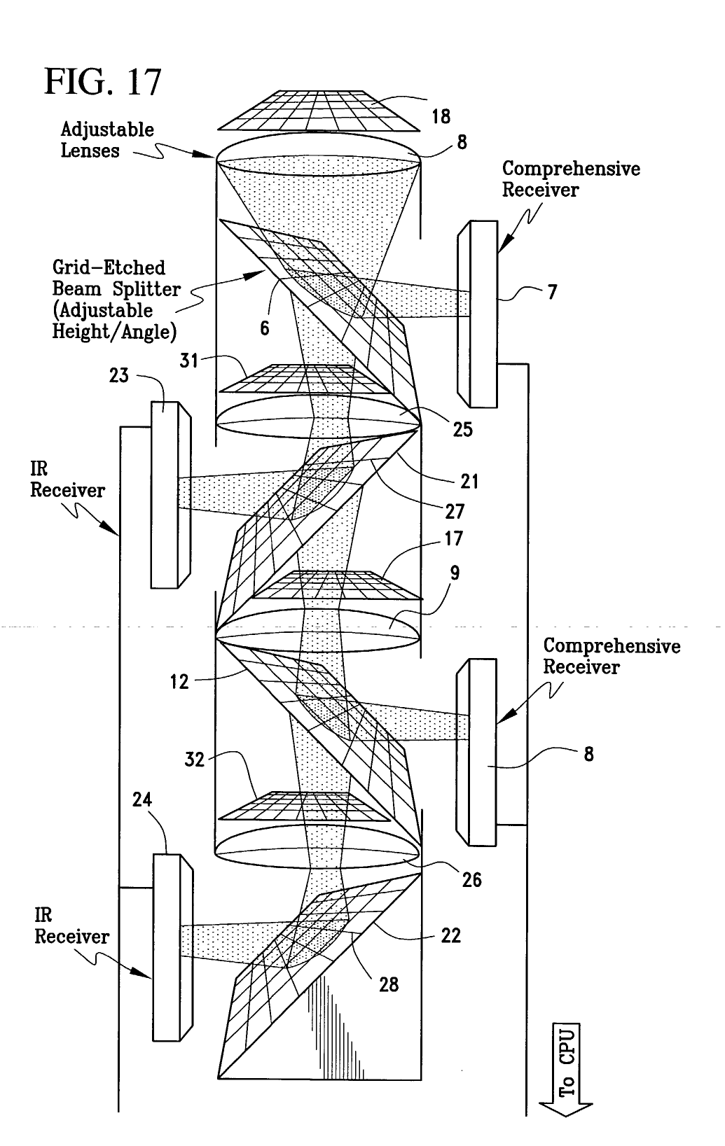

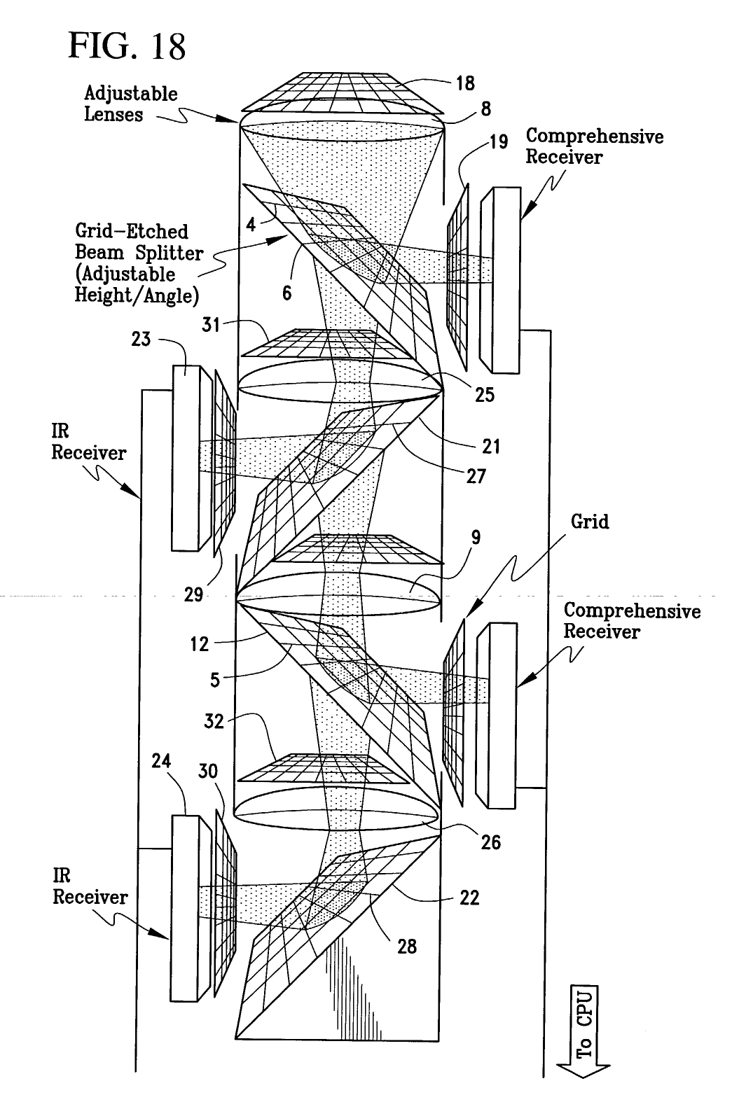

Finally, as illustrated in FIGS. 15-18, additional beam splitter 21, mirror 22, receivers 23,24, lenses 25,26, and grids 27-32 may be added to separate out different wavelengths of the background image, either by using wavelength sensitive beam splitters, by using specific wavelength sensitive receivers, or by a combination of the wavelength sensitive beam splitters and receivers. For example, infrared receivers may be used to acquirement temperature date in order to form a thermal profile of an object in the background image, which is useful for tracking and identification of incoming missiles or aircraft, although the wavelength sensitive receivers need not be limited to infrared receivers. It will be appreciated that it may also be desirable to separate each of the grids by frequency even in visible light applications, so that each image clearly includes a separate grid.

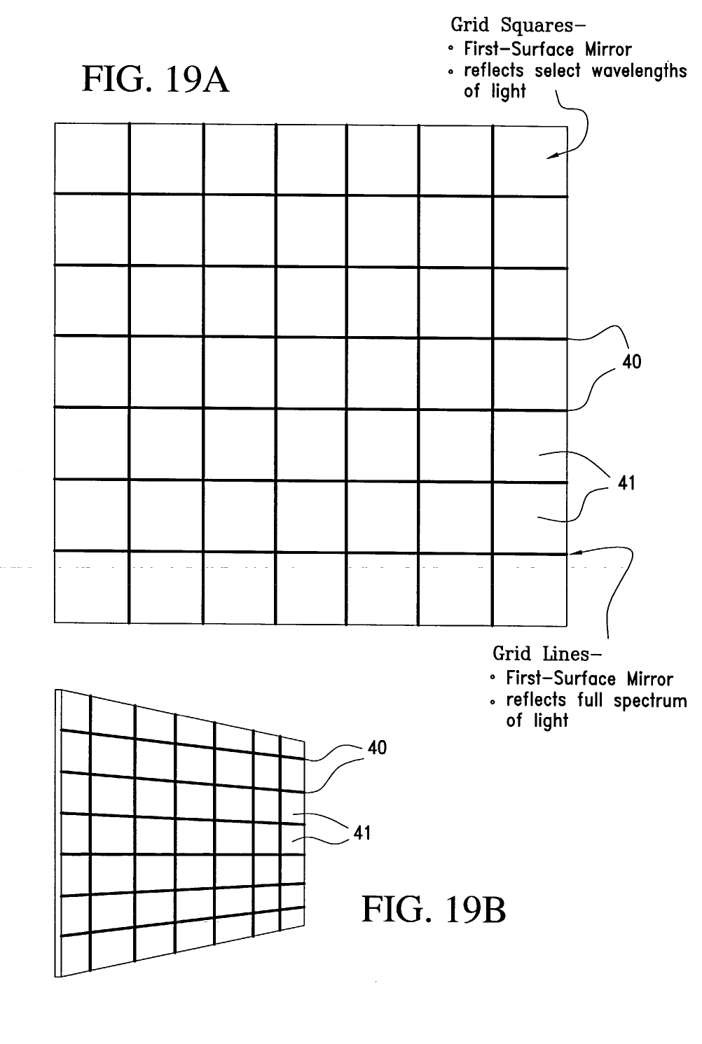

To facilitate separation or processing of the foreground grid or pattern, the preferred embodiments of the invention may utilize the unique mirror construction illustrated in FIGS. 19A and 19B. This is accomplished by treating a surface of a reflective or beam-splitting mirror in such a manner that a pattern is formed on the mirror surface, either through the used of a coating, by forming the mirror of different materials, or by appropriate surface treatment methods, such that the pattern reflects a different set of wavelengths than the remaining surface of the mirror. For example, the pattern may be a grid 40, each of the lines of which reflect a full spectrum of light, while the squares 40 formed by the grid reflect only selected wavelengths. Alternatively, the grid may be selectively reflective while the squares reflect a full-spectrum or a different spectrum than that reflected by the grid. Separation of the images reflected by the grid lines and the squares may then be achieved by using receivers sensitive to the different wavelengths, or by wavelength-sensitive beam splitting arrangements of the type disclosed in copending U.S. patent application Ser. Nos. 09/969,583, 09/987,336, and 10/050,538.

Having thus described various preferred embodiments of the invention in sufficient detail to enable those skilled in the art to make and use the invention, it will nevertheless be appreciated that numerous variations and modifications of the illustrated embodiment may be made without departing from the spirit of the invention. For example, multiple data acquisition or imaging devices corresponding to those of the preferred embodiment may be combined or linked together to generate stereoscopic images, and the devices may otherwise be modified for integration into a variety of apparatus or systems, including defense or homeland security related surveillance systems, detectors for use in physics, chemistry, and other scientific experiments, and in vehicle guidance systems.

It is therefore intended that the invention not be limited by the above description or accompanying drawings, but that it be defined solely in accordance with the appended claims.

I claim:

1. A method of acquiring data correlated with three-dimensional geometric features or location of a subject, comprising the step of passively acquiring the data by comparing changes in the size of the subject relative to changes in the size of features of a foreground through which the background is viewed as an optical path length between the foreground and an image plane is varied.

2. A method of acquiring data correlated with three-dimensional geometric features or location of a subject, comprising the steps of:
a. capturing a composite image of a background object and a foreground pattern at a first distance from an image plane;
b. capturing a composite image of the background and foreground in which the foreground pattern is situated at a second distance from an image plane;
c. comparing the relative sizes of features of the background object and the foreground pattern in the two composite images relative to a fixed set of coordinates.

3. A method as claimed in claim 2, wherein steps a and b are performed simultaneously.

4. A method as claimed in claim 2, wherein the foreground pattern is a grid.

5. A system for acquiring data correlated with three-dimensional geometric features or location of a subject, comprising a camera arranged to capture two composite images of a background object through a foreground pattern at different focal lengths, and means for comparing the two composite images in order to determine the amount by which dimensions of the background change relative to dimensions of the foreground image as the focal length is changed.

6. A system as claimed in claim 5, wherein said camera includes two said foreground patterns, and two receivers for simultaneously capturing said composite images through the two respective foreground patterns.

7. A system as claimed in claim 6, wherein said foreground patterns are grids.

8. A system as claimed in claim 6, wherein said camera further includes at least one beam splitter for splitting an image of the background object and directing the image to separate optical paths through the respective foreground patterns.

9. A system as claimed in claim 8, wherein at least one of said foreground patterns is situated on said beam splitter.

10. A system as claimed in claim 9, wherein said one of said foreground patterns is a grid etched into said beam splitter.

11. A system as claimed in claim 10, further comprising a mirror having an adjustable angle for directing a composite background/foreground image at said second receiver.

12. A system as claimed in claim 10, wherein a second of said foreground patterns is a grid etched into said mirror.

13. A system as claimed in claim 8, wherein at least one of said foreground patterns is situated between said at least one beam splitter and a corresponding said receiver.

14. A system as claimed in claim 13, wherein a second of said foreground patterns is situated between said at least one beam splitter and a corresponding second one of said receivers.

15. A system as claimed in claim 8, wherein a number of said beam splitters is at least two, and a number of said receivers is at least three.

16. A system as claimed in claim 15, wherein a number of said foreground patterns is at least three.

17. A system as claimed in claim 16, wherein said foreground patterns are grids.

18. A system as claimed in claim 8, further comprising at least one second beam splitter and at least one third receiver arranged to capture a composite image of the background image and a foreground pattern at selected wavelengths that differ from a set of wavelengths to which said first and second receivers are responsive.

19. A system as claimed in claim 18, wherein said selected wavelengths are infrared wavelengths.

20. A system as claimed in claim 19, further comprising a second infrared beam splitter and receiver.

21. A mirror construction, comprising:
a mirror surface having a reflective pattern formed thereon, wherein the pattern reflects a different set of frequencies than portions of the mirror surface that do not have the pattern formed thereon.

22. A mirror construction as claimed in claim 21, wherein the pattern is a grid.
